(19) United States
(12) Patent Application Publication
(10) Pub. No.: US 2018/0010368 A1
(43) Pub. Date: Jan. 11, 2018

(54) Method and device for handcuffs

(71) Applicant: Yaniv Herman, Lod (IL)

(72) Inventor: Yaniv Herman, Lod (IL)

(21) Appl. No.: 14/818,363

(22) Filed: Aug. 5, 2015

(51) Int. Cl. E05B 75/00

(52) U.S. Cl. CPC E05B 75/00

(57) ABSTRACT

This present Invention provides novelty in the method and the device for handcuffs which are purpose-built for constraining the hands of the handcuffed person, where the method enables handcuffs which can constrain both hands of the handcuffed person, and where an extension to the handcuffs provides, additionally, a means to allow the constraining of finger movements of the handcuffed person, such that both wrists of the handcuffed person are one against the other and the fingers of his one hand are against the fingers of his other hand, thus limiting to some degree their natural freedom of movement by the method and device of the handcuffs which constitute this present Invention.

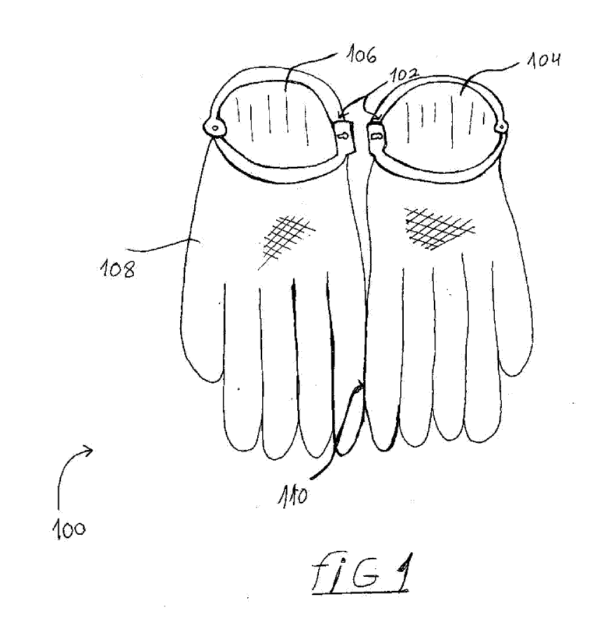

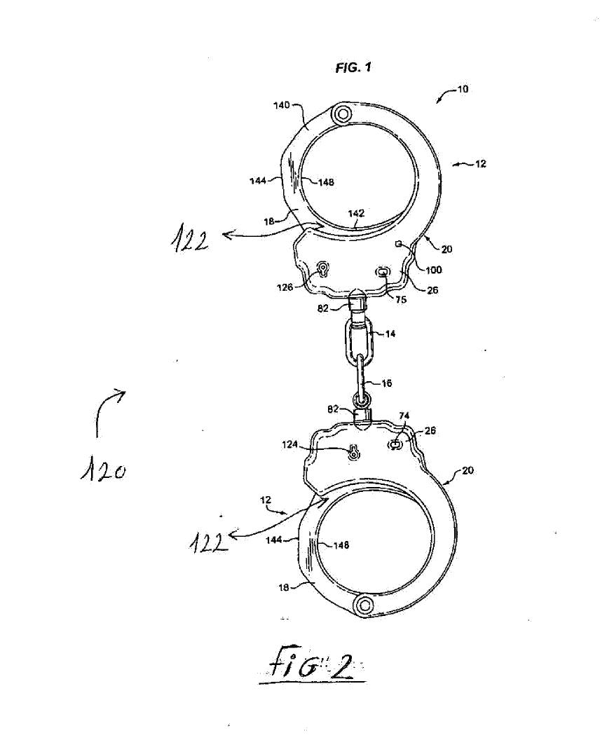

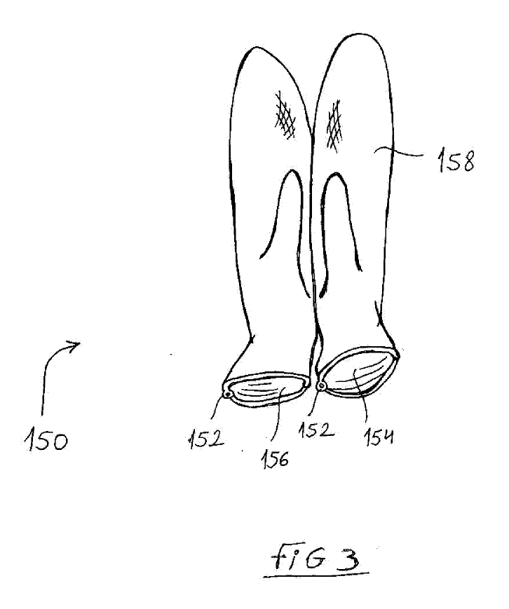

### BACKGROUND OF THE INVENTION

This present invention is in the field of handcuffs, and more specifically, this present Invention combines a handcuff method and instrument which enables the user to handcuff the hands of the person to be handcuffed, and, at least to a certain extent, also to immobilize the fingers of his hands one against another.

It is known to a person skilled in the art that handcuffs, which are used to limit the movement of the hands of the person on whom the handcuffs are put, is a device already in existence for hundreds of years, in various configurations which enable the securing of one hand of the handcuffed person to his other hand, such as to prevent the handcuffed person from moving both hands freely, as he could before the use of the handcuffs.

Handcuffs are characteristically used on people who have been arrested or are imprisoned by law-enforcement agencies, for example prisoners imprisoned in a prison or arrestees detained by the police.

Such arrestees or prisoners, whose freedom of movement is limited by law, or by a court order, or by the authority of a person in authority, in general, when they are transferred from secure premises, for example from a prison cell or from a police cell, the person in authority has the desire to prevent the escape of these arrestees or prisoners or any aggressive act on their part, and thus constrains their full bodily freedom of movement, for example of their arms and sometimes also of their legs; this is a common and necessary situation.

There are additional methods for constraining the movement of the body members of a person, for example a person in lawful custody, for example a straightjacket, used principally in institutions dealing with mental health problems. Such a straightjacket includes sleeves for the arms and hands which imprison the arms of the person wearing the straightjacket inside the straightjacket, with no possibility of movement.

This present Invention provides novelty in situations where there is a need for handcuffs which also constrain the movement of the fingers of the handcuffed person, in such a manner that the fingers of each hand do not have their normal freedom of movement comparing the finger of the second hand of the user.

The need for a solution to the constraining of finger movement of the handcuffed person is indicated by the fact that in handcuffs presently-available to the police, for example one wrist is secured against the other wrist by two handcuff clamps, secured to each other with by a connector; in this situation the fingers of the hand of the handcuffed person are free. This fact gave rise, not infrequently, to the situation where an arrestee for example performed a forbidden action with the fingers of his hand, for example taking control of a policeman's gun.

The method of this present Invention enables handcuffs which enable the securing of the wrists of the handcuffed person one to the other, where additionally, an additional part of the device of this present Invention fits over at least part of the fingers of the handcuffed person, such that it joins the fingers of one of the handcuffed person's hand to the fingers of his other hand. This is made possible by part of the device providing a separation between the handcuffed person's fingers.

### SUMMARY OF THE INVENTION

This present Invention provides novelty in the method and the device, and enables a handcuffing device, which enables the securing of the handcuffed person's wrists one to the other, such as to limit their freedom of movement, and additionally, such that an additional part of the device of this present Invention fits over at least part of the fingers of the handcuffed person, or immobilizes a specific part of his fingers in such a way as to secure at least part of the fingers of the handcuffed person's one hand to the fingers of his other hand.

Opening and closing of at least one or more specific parts of the device, according to need, is provided, in a manner that enables widening of part of the section of the handcuffs which is made for the insertion of the wrists of the person to be handcuffed, one against the other, in such a manner as to enable the introduction of the wrists of the person to be handcuffed, where this part can be made narrow again, for example after the insertion of the hands of the person to be handcuffed, and where it is also possible to lock at least one part of the handcuff device by narrowing and then widening again, to suit.

Additionally, a particular part of the device enables, the putting-on glove-like bags over the fingers or part of the fingers of the handcuffed person, the glove-like bags being effectively connected to each other in such a way as to deny the handcuffed person the possibility to move his fingers freely

### BRIEF DESCRIPTION OF THE DRAWINGS

The accompanying drawings are included in this present Patent Application with the objective of providing a greater understanding of the Invention, and are included and form an integral part of this present specification. The drawings illustrate various embodiments of the Invention, and together with the description, serve the purpose of clarifying the principles and the method of operation of the Invention, all exclusively as examples, and not with the objective of limiting the Invention to these and only these descriptions.

Drawing 1 is a schematic description which illustrates an example, which is included in the scope of this present Invention, and which illustrates a handcuffing device which includes parts of the device which enable the restriction of the freedom of movement of the fingers of the person upon whom the handcuffs are put, according to the method and the device of this present Invention.

Drawing 2 is a schematic description of handcuffs in existence in the prior art, in U.S. Patent Application 2005/0262895 A1 before the invention of the method and device of this present Invention.

Drawing 3 is a schematic description which illustrates a further example included within the scope of this present Invention, which illustrates a handcuffing device which includes a part of the device which enables the restriction of the freedom of movement of the fingers of the person upon whom the handcuffs are put, according to the method and the device of this present Invention.

### DESCRIPTION OF THE PREFERRED EMBODIMENTS

The description of the drawings of this annex and the drawings to which reference is made are included within this Patent Application with the objective of providing greater understanding of the Invention, and are included and form an integral part of this specification. The description of the drawings provides a more detailed explanation of the different embodiments of the invention, and, together with the drawings themselves, and the other components of the Patent Application document, serve the purpose of explaining the principles and the method of operation of the Invention, all exclusively as examples, and not with the objective of limiting the Invention to these and only these descriptions.

Drawing 1 is a schematic description which illustrates an example, which illustrates handcuffing device 100, which includes opening device parts 102, and enables through them to increase the diameter of the entry opening and the insertion through this opening of the hands of the person being handcuffed, where the hands of the person being handcuffed are inserted into openings 104 and 106, and his fingers are inserted according to the intended position of each finger in the glove-shaped part 108 of the device, where there is separator 110 inside glove 108, which prevents contact of the fingers of one hand of the handcuffed person with the fingers of his second hand, this in a manner which enables the restriction of movement of the fingers of the handcuffed person, according to the method and the device of this present Invention.

Drawing 2 is a schematic description which illustrates handcuffs 120, which exist in the prior art before the invention of the method and device of this present Invention, where clamp 122 enables opening, closing and locking, according to need, in order to enable the insertion and the locking of the wrists of the person being handcuffed.

Drawing 3 is a schematic description which illustrates an example which is included in the scope of this present Invention, which illustrates handcuffing device 150, which includes opening device 152 which can be have the diameter of its opening widened for the insertion and withdrawal of the hand of the person being handcuffed, where the hands of the person being handcuffed are inserted through openings 154 and 156, and his fingers are inserted according to the intended position of each finger in the glove-shaped part 158 of the device, this in a manner which enables the restriction of movement of the fingers of the handcuffed person, where at this stage, openings 154 and 156 are closed and tightened and fitted to the wrists of the person being handcuffed with the device 150, until the person being handcuffed can no longer remove the device from his hands; thus the locking the diameter of the opening, as decided by the person in authority, is enabled via lock 158, as per the method and the device of this present Invention.

This present Invention is not limited to the above-described embodiments, but includes all of the following claims, and all embodiments within the scope of the following claims:

1. This present Invention provides novelty in the method which enables purpose-made handcuffing systems to be placed upon the hands and on the fingers of a person in order to limit the freedom of movement of his/her hands and fingers, where the method consists of the following elements:
a. Device which includes one or more openable parts where the insertion and removal opening diameter can be widened, with the objective of inserting, withdrawing and locking the device on the hand of the user, or his wrist.
b. The user's hands are inserted into these openings up to the area of the wrist of the person upon whom the handcuffs are put.
c. The user's fingers are inserted according to the intended position for each finger in the glove-shaped part of the device which is situated at the front of the device.
d. Optionally, it is possible to have a separation inside the glove, which prevents contact between the fingers of one hand of the user with the fingers of his other hand, this in a manner which enables the restriction of movement of the fingers of the handcuffed person, according to the method and the device in this present Invention.
e. The part of the device which can be widened and narrowed encircles the user's wrist area, such as to make it impossible to remove the device by pulling it away from his hands.
f. Locking the device fixes the position of the lock which closes and secures the device to the user's wrists.

2. Claim as claim 1, where the method enables to implement the device by means of a glove which does not have a pocket for each finger, but has a bag for the insertion of the fingers of each hand, and optionally, there is a separation between the fingers of one hand and the fingers of the other hand, so that they do not come into contact with each other.

3. This present Invention provides novelty in handcuffing devices purpose-made for placing upon the hands and upon the fingers of a person, in order to limit the freedom of movement of his hands and fingers, where the device consists of the following elements:
a. The device includes one or more openable parts which enable the widened of the diameter of the insertion and withdrawal opening for the purpose of inserting, withdrawing and locking the device upon the user's hands or upon his wrists.
b. The user's hands are inserted into these openings up to the area of the wrists of the person to be handcuffed.
c. The user's fingers are inserted according to the intended position for each finger in the glove-shaped part of the device which is situated at the front of the device.
d. Optionally, it is possible to have a separation inside the glove, which prevents contact between the fingers of one hand of the user with the fingers of his other hand, this in a manner which enables the restriction of movement of the fingers of the handcuffed person, according to the method and the device in this present Invention.
e. The part of the device which can be widened and narrowed encircles the user's wrist area, such as to make it impossible to remove the device by pulling it away from his hands.
f. Locking the device fixes the position of the lock which closes and secures the device to the user's wrists.

4. Claim as claim 3, where the part of the device which constrains or accommodates the user's fingers may be made from one or more types of material, and is of course not limited to any particular types of material for the purpose of implementing the novelty condition of the Invention.

5. Claim as claim 3, where the part of the device which constrains or accommodates the user's fingers may be adjusted for different finger sizes by means of a mechanism which enlarges or shrinks this part of the device.
